(19) United States
(12) Patent Application Publication
(10) Pub. No.: US 2017/0036215 A1
(43) Pub. Date: Feb. 9, 2017

(54) Guide Roller Of A Pair Of Feed Rollers Of A Granulating Device

(71) Applicant: Maag Automatik GmbH, Grossostheim (DE)

(72) Inventor: Thomas Willemsen, Hanau (DE)

(21) Appl. No.: 15/306,014

(22) PCT Filed: Apr. 17, 2015
(86) PCT No.: PCT/EP2015/000817

§ 371 Date: Oct. 21, 2016

(30) Foreign Application Priority Data
Apr. 22, 2014 (DE) 20 2014 003 409.5

(51) Int. Cl. B02C 18/22; B65H 20/02; B29B 9/06; F16C 13/00

(52) U.S. Cl. CPC B02C 18/2283; F16C 13/00; B65H 20/02; B29B 9/06

(57) ABSTRACT

Guide roller of a pair of feed rollers of a granulating device for plastic strands, wherein the guide roller has a core and at least one outer hard rubber layer, wherein the at least one outer hard rubber layer forms a sleeve that can be pushed onto the core of the guide roller and pulled off of the core.

### FIELD OF THE INVENTION

The invention concerns a guide roller of a pair of feed rollers of a granulating device for plastic strands. The guide roller has a core and at least one outer hard rubber layer.

### BACKGROUND OF THE INVENTION

From the document EP 0 013 575 A1, a granulator is known for granulating plastic strands that has such a pair of feed rollers, wherein the rollers of the pair of feed rollers have lateral surfaces made of steel. In contrast to this application, granulating devices with such a pair of feed rollers usually have a drive roller and a guide roller. In this design, the drive roller can certainly have lateral surfaces made of steel.

The guide roller, which feeds the plastic strands of the granulating device to the granulator, for example by pressing down the plastic strands, usually has a core, however, and at least one outer hard rubber layer, such as is known from the document DE 197 01 926 C2, although in this document the outer hard rubber layer is profiled and has slots and rubber webs in the longitudinal direction that can yield in order to adjust to different plastic strand thicknesses. Nonetheless, the various guide rollers have in common that in the event of wear of the hard rubber layer, be it with or without longitudinal slots and longitudinal webs, the entire guide roller must be recoated at great effort.

In this process, not only are installation costs incurred in uninstalling the guide roller to be replaced and installing a newly coated guide roller, but also transport costs and storage costs, especially since multiple feed rollers are in circulation for removal of used hard rubber layers and for the construction of new hard rubber layers.

From the document DE 199 50 643 A1 a rubber cylinder sleeve is known for web-fed offset rotary presses that has an inner support sleeve that can be expanded by air, a compressive layer arranged thereon, and lastly an outer cover layer. In this design, these layers have joint locations at which the layers, which are assembled from sheets, are welded or glued together to form a cylindrical coating.

This butt joint of a rubber cylinder sleeve is noncritical in web-fed offset rotary presses, since the joint location can be synchronized in its rotation with an expansion channel of a cylinder that has printing plates on its lateral surface between the axially oriented expansion channel. However, this option for compensating the unevenness of joint locations does not exist for guide rollers of a granulating device having an outer hard rubber layer, for which it is necessary to remove the remaining layer at the end of the service life of the hard rubber layer and typically vulcanize a new hard rubber layer onto a cylindrical metallic core.

### SUMMARY OF THE INVENTION

The object of the invention is to create a guide roller with which the disadvantages of the prior art are overcome, and transport and storage costs can be saved, in the replacement of guide rollers having an outer hard rubber layer.

One embodiment of the invention has a guide roller of a pair of feed rollers of a granulating device for plastic strands. The guide roller has a core and at least one outer hard rubber layer. The at least one hard rubber layer forms a sleeve that can be pushed onto the core of the guide roller and pulled off of the core.

This sleeve, composed at least of an outer hard rubber layer, has the advantage that the hard rubber no longer needs to be vulcanized onto the core of the guide roller. Moreover, removal from the core is made easier in that the hard rubber sleeve is simply pulled off of the core. Considerable installation time can be saved through this system of replacement of the sleeve. Since only the sleeve made of a hard rubber material must be replaced in the event of damage or wear, the customer can easily and straightforwardly order a new sleeve of hard rubber and draw it onto the remaining core himself. The necessity for complete removal of the guide roller for recoating of the core is eliminated, and shipment of the guide roller for recoating is eliminated. Since no more guide rollers are in circulation for coating removal and coating application, by vulcanization for example, the costs for inventory management as well as the costs incurred for outbound and return transport and shipping with each recoating can be reduced for the customer. Relatively simple replacement of guide rollers with different hard rubber properties for different strand materials to be granulated is also possible in this way.

In another embodiment, provision is made that at least one of the end regions of the core has an external thread. Furthermore, the guide roller has a ring nut that can be threaded onto this external thread of the core in the end region. The ring nut for its part can have a first conical surface that engages a first mating conical surface of the outer hard rubber layer that forms a sleeve. An opposite end region of the core has a second conical surface that engages an opposite second mating conical surface of the outer hard rubber layer that forms a sleeve. In this way, the one sleeve is centered by its two mating conical surfaces between the two conical surfaces of the core and the ring nut.

With this embodiment it is possible to ensure in an advantageous manner that, despite a minimal cylindrical gap between the lateral surface of the core of the guide roller and an inside surface of the sleeve comprising at least one hard rubber layer, no imbalance occurs in operation, since the conical surfaces and mating conical surfaces center the hard rubber layer relative to the axis of rotation of the guide roller. Suitable hardness and stiffness of a self-centering hard rubber sleeve of this type ensures that no change in shape of the outer hard rubber layer occurs during clamping and centering of the same between the conical surfaces of the core and ring nut.

For the case in which the frictional connection between conical surfaces and mating conical surfaces does not suffice to prevent rotation of the hard rubber layer that forms a sleeve relative to the core of the guide roller, provision is made in another embodiment of the invention that a key that is oriented in the axial direction projects from the, e.g., cylindrical core. In this design, the key engages positively with an inner longitudinal groove of the outer hard rubber layer during the pushing on and the pulling off. With this positive engagement it is possible to ensure that the sleeve made of hard rubber maintains its position over the core, also referred to as registration or registration position, during operation.

Alternatively, the sleeve of the hard rubber layer can have an internal cone over the entire guide roller width in the axial direction that can be frictionally connected to an external cone of the core. An elongated internal cone of this nature in combination with the external cone of the core makes it possible to provide a releasable and frictional bond between the core and the hard rubber layer that forms a sleeve. In addition, the axial positioning between the core with the external cone and the sleeve with the internal cone can be secured by a ring nut.

Should the frictional connection between the external cone of the core and internal cone of the sleeve not suffice to prevent rubbing and slipping between the conical core and the conical sleeve, it is likewise possible for a key that is arranged in a longitudinal groove of the sleeve to project from the external cone of the core, thereby ensuring positive engagement between the core and the sleeve.

In the event that the hardness and stiffness of the hard rubber layer are not sufficient to provide a self-supporting, deformation-resistant sleeve of this nature, provision is made in the alternative that the outer hard rubber layer is vulcanized or adhesive bonded or clamped onto a reinforcing cylinder. This has the advantage that outer rubber layers can also be provided that are more flexible and elastic than conventional hard rubber layers, either in that they have the known longitudinal slots or longitudinal webs or in that the material is extraordinarily pliable and can adapt better to different strand thicknesses.

Furthermore, provision is made that the reinforcing cylinder has the mating conical surfaces that are arranged such that they are clamped and centered between the front conical surface of the core and the conical surface of the ring nut. As a result, the reinforcing cylinder takes on the centering and clamping of the rubber layer forming a sleeve, which now does not necessarily have to have a hard rubber, since the sleeve now forms a composite consisting of the rubber layer and reinforcing cylinder. For anti-rotation protection between the reinforcing cylinder and the outer shell of the core, the reinforcing cylinder can have an inner longitudinal groove that engages with the key projecting from the outer shell of the core.

The reinforcing cylinder that reinforces the rubber layer can have a thermosetting plastic, a fiber-reinforced plastic, or a metal alloy. Each of these three materials has different advantages and disadvantages, which may be applicable to the guide roller depending on the cost structure, storage options, and thermal requirements. A thermosetting plastic is characterized by relatively high thermal stability, thermal and electrical insulation, and great deformation resistance. A sleeve carrier made of fiber-reinforced plastic has the advantage of low weight, high thermal and electrical insulation, and economical production. A sleeve carrier made of metal has good thermal conductivity and high electrical conductivity to dissipate electrostatic charging of the hard rubber layer forming a sleeve. Furthermore, the metallic material makes possible very precise machining and polishing of the mating conical surfaces for adjusting the sleeve, so that centering can take place very reproducibly and reliably during clamping between the conical surfaces with the aid of the first, preferably metallic, conical surface of the ring nut and the second, preferably likewise metallic, conical surface in the end region of the core.

In another embodiment of the invention, a sleeve carrier is arranged between the outer hard rubber layer forming a sleeve and the core, on which sleeve carrier the hard rubber layer is arranged with or without a reinforcing cylinder.

In order to center and to clamp the hard rubber layer with or without a reinforcing cylinder, a first end region of the sleeve carrier has an external thread onto which can be threaded the one ring nut that has a first conical surface. The first conical surface of the ring nut engages a first mating conical surface of the outer hard rubber layer that forms a sleeve. Located on an opposite second end region of the sleeve carrier is another conical surface that engages an opposite second mating conical surface of the outer hard rubber layer that forms a sleeve. The sleeve with its mating conical surfaces is centered by the conical surfaces of the sleeve carrier and of the ring nut. In this way, the sleeve carrier takes over the above-described function of a core with a first conical surface of the ring nut applied to one end region and a second conical surface on a second end region of the sleeve carrier.

This has the advantage that the profile and the lateral surface of the core can be designed freely. The core can have a round profile in cross-section, so that a key-and-groove connection between the core and the sleeve carrier may possibly be necessary. However, the core can also have profiles or cross-sections that positively engage with corresponding internal profiles of the sleeve carrier. Thus, instead of being cylindrical, the core can have a triangular, square, hexagonal, or polygonal profile, for example. Moreover, it is possible to provide a ball and groove connection or roller and groove connection in place of a key-and-groove connection. Furthermore, it is possible for the core to have a bead at one position of the roller width that engages a recess in the sleeve carrier. The core can also have a flat surface toward one end that engages a corresponding projection from the inner surface of the sleeve carrier.

In another embodiment of the invention, provision is made that the sleeve carrier is an integral part of the core, wherein the core and sleeve carrier can be integrally joined, for example by an adhesive layer.

Furthermore, provision is made that the core of the guide roller has, arranged at the ends, journals that are rotatably supported in a housing of the granulating device. These journals arranged at the ends can be arranged on any desired shape of central core of the guide roller. If a hollow shaft is provided as the core, then the core has, in its end regions, end plates from which the journals can project. According to the invention it can be especially preferred when the guide roller according to the invention can also be raised from the drive roller, which preferably is rotatably mounted in a fixed position in the housing, for easier access on account of its pivotability.

Alternatively, it is also possible that the core of the guide roller has a hollow shaft that is rotatably supported on a fixed axle. To this end, at least one floating bearing and one fixed bearing are arranged on the fixed axle, ensuring that a hollow cylinder can rotate on the fixed axle as a hollow shaft.

In another embodiment of the invention, provision is made that the core of the guide roller has radial bores that communicate with a central axle bore, wherein the central axle bore of the core has a compressed air connection. Through this compressed air connection, compressed air can be directed from the radial bores onto the inner surface of either a hard rubber layer forming a sleeve, or else onto a reinforcing cylinder of the hard rubber layer.

In order to be able to exert a pressure on the inner surface of a hard rubber layer or of a hard rubber layer with reinforcing cylinder with the compressed air, and thereby facilitate the pulling off or pushing on of the sleeve made of hard rubber that is to be replaced, provision is made that an intermediate layer having a compressible material is arranged between the hollow shaft with radial openings, or the hollow shaft with radial bores, and the hard rubber layer or a reinforcing layer. When compressed air is applied to the radial bores or radial openings, the compressible layer is pressed outward against the inner surface of the hard rubber layer or reinforcing cylinder, forming a compressed air gap that significantly eases the pulling off or pushing on of the hard rubber layer or the reinforcing cylinder with hard rubber layer.

### BRIEF DESCRIPTION OF THE DRAWINGS

The invention is described in detail below using the embodiments explained by way of example.

FIG. 1 shows a schematic perspective outside view of a guide roller with replaceable outer hard rubber layer according to a first embodiment of the invention;

FIGS. 2, 2A and 2B show a schematic perspective view of the guide roller from FIG. 1 with regions partially shown in longitudinal cross-section;

FIG. 3 shows a schematic longitudinal cross-section of the guide roller from FIG. 1;

FIG. 4 shows a schematic longitudinal cross-section of a guide roller according to a second embodiment of the invention;

FIG. 5 shows a perspective view with a region partially in longitudinal cross-section of a guide roller with replaceable outer hard rubber layer according to a third embodiment of the invention;

FIG. 6 shows a schematic longitudinal cross-section of a guide roller according to a fourth embodiment of the invention;

FIG. 7 shows a schematic longitudinal cross-section of a guide roller according to a fifth embodiment of the invention;

FIG. 8 shows a schematic longitudinal cross-section of a guide roller according to a sixth embodiment of the invention;

FIG. 9 shows a schematic perspective outside view of a guide roller with replaceable outer hard rubber layer according to a seventh embodiment of the invention;

FIG. 10 shows a schematic longitudinal cross-section of a guide roller from FIG. 9;

FIG. 11 shows a schematic longitudinal cross-section of a guide roller according to an eighth embodiment of the invention;

FIG. 12 shows a schematic longitudinal cross-section of a guide roller according to a ninth embodiment of the invention;

FIG. 13 shows a schematic longitudinal cross-section of a guide roller according to another embodiment of the invention;

FIGS. 14A to 14F show schematic cross-sections of a guide roller with positive engagements between the hard rubber layer, a sleeve carrier, and the core of the guide roller;

FIG. 15 schematically shows the use of a guide roller according to the invention in a strand pelletizing apparatus.

### DETAILED DESCRIPTION OF THE INVENTION

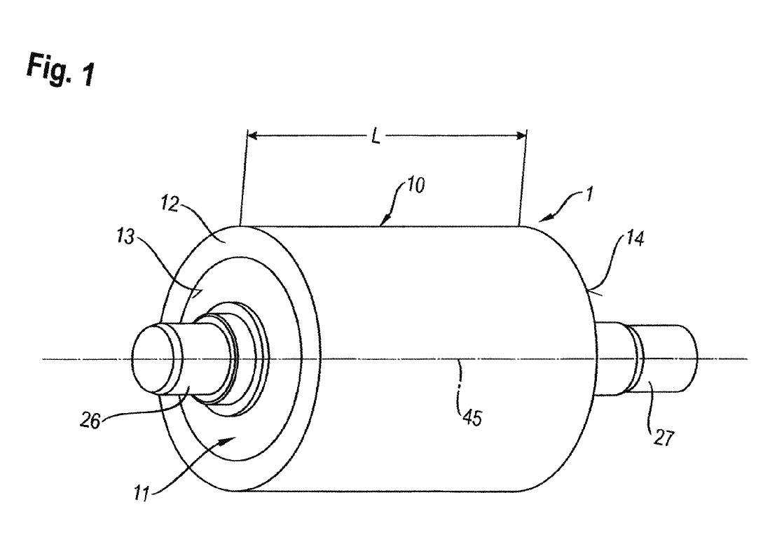

FIG. 1 shows a schematic perspective outside view of a guide roller 1 with replaceable outer hard rubber layer 12 according to a first embodiment of the invention. The outer hard rubber layer 12 forms a sleeve 10 that is arranged on a core 11 of the guide roller 1 such that it can be pulled on or pushed off. For this purpose, the outer hard rubber layer 12 covers the entire roller width L coaxially to the axis 45 of the guide roller 1. FIG. 1 also shows a first end region 13 with a first journal 26 and a second end region 14 with a second journal 27, wherein the journals 26 and 27 project from the lateral end regions 13 and 14, for example in order to pivotably support the guide roller 1 in a granulator housing.

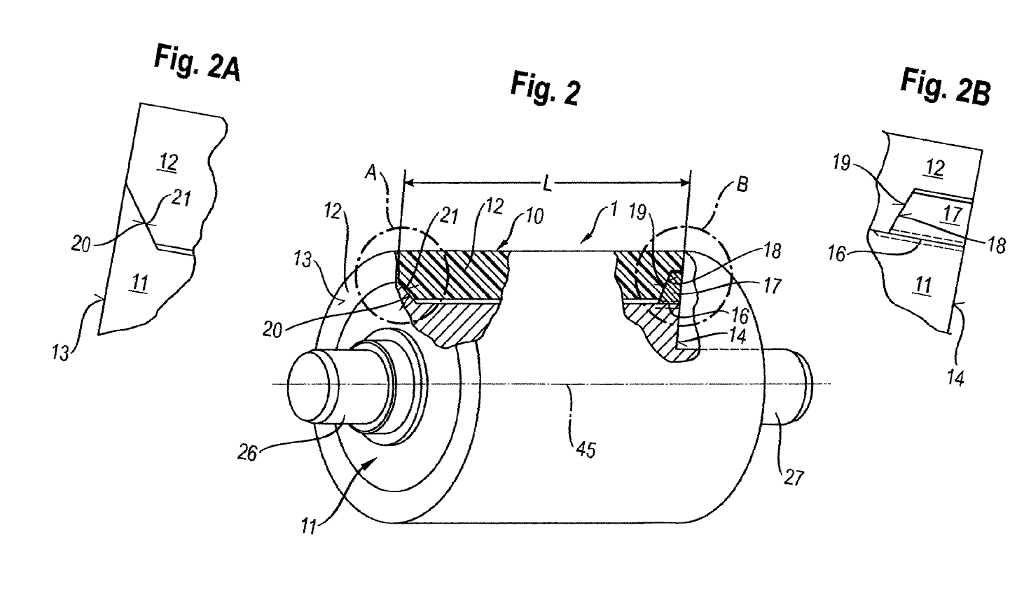

FIG. 2 shows a schematic perspective view of the guide roller 1 from FIG. 1 with regions partially shown in longitudinal cross-section. The regions A and B of the guide roller 1 partially in longitudinal cross-section illustrate the internal structure and the components that make it possible to ease the pulling off of a used hard rubber layer 12 and the pushing on of a reconditioned or new outer hard rubber layer 12 on the core 11 of the guide roller 1.

To this end, FIG. 2A shows the detail A in enlarged longitudinal cross-section, wherein the outer hard rubber layer is labeled with the reference symbol 12. Located in the end region 13 of the core 11, between the outer hard rubber layer 12 and the end region 13 of the guide cylinder 1 shown in FIG. 2A, is a conical surface 20 that engages a mating conical surface 21 of the hard rubber layer 12. Arranged on the core 11 in the opposite end region 14, whose longitudinal cross-section is shown enlarged in FIG. 2B, is an external thread 16 that engages an internal thread of a ring nut 17. The ring nut 17 has a conical surface 18 that in turn engages a mating conical surface 19 of the hard rubber layer 12. As a result of the design of the conical surfaces 18 and 20 and the mating conical surfaces 19 and 21 of the hard rubber layer 12, the latter is centered on the core of the guide roller 1 and is frictionally clamped between the conical surfaces 20 of the core 11 and 21 of the ring nut 17.

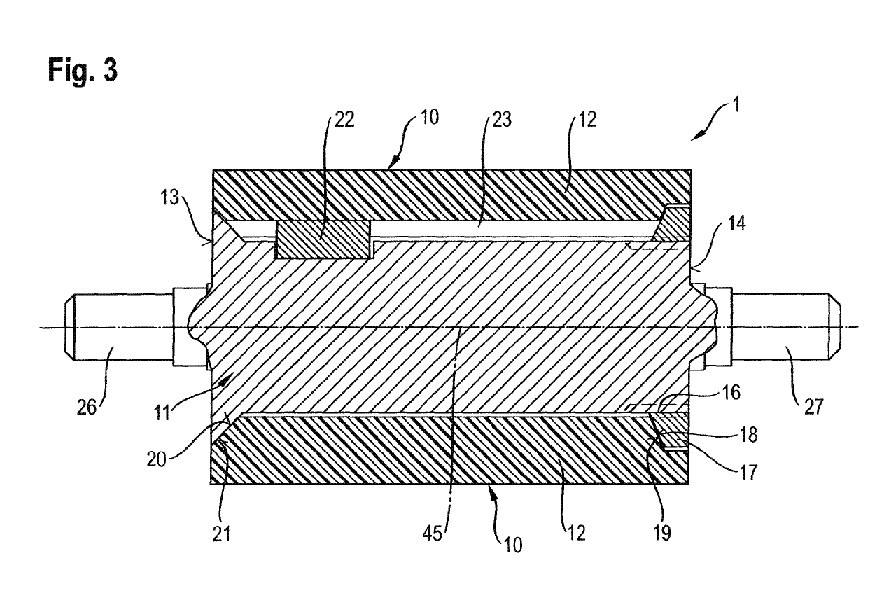

FIG. 3 shows a schematic longitudinal cross-section of the guide roller 1 from FIG. 1. In the event that the clamping action and frictional connection between the conical surfaces 19 and 21 and the mating conical surfaces 18 and 20 is not sufficient to prevent rotation of the outer hard rubber layer 12 relative to the core 11, an option for a connection with positive engagement in addition to the frictional connection between the conical surfaces 18 and 20 and the mating conical surfaces 19 and 21 is shown with FIG. 3. To this end, the core 11 of the guide roller 1 has a key 22 that projects from an outer lateral surface of the core 11 and engages an inner longitudinal groove 23 of the outer hard rubber layer 12.

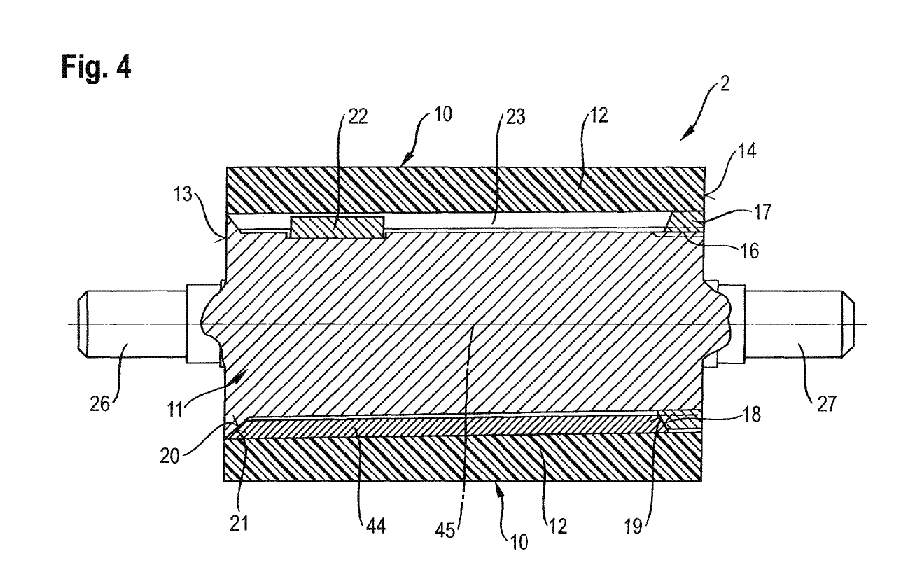

In FIGS. 4 to 14 that follow, components of different embodiments of the invention that have the same functions as in FIGS. 1 to 3 are labeled with the same reference characters and are not discussed separately.

FIG. 4 shows a schematic longitudinal cross-section of a guide roller 2 according to a second embodiment of the invention. In this second embodiment, the hard rubber layer 12 that forms a sleeve 10 is stabilized and supported by a reinforcing cylinder 44 onto which the hard rubber layer 12 can be vulcanized, adhesive bonded, or clamped. The reinforcing cylinder 44 now substantially has the centered mating conical surfaces 19 and 21, so that the hard rubber layer 12 is not loaded by the centering forces that arise. To this end, the reinforcing cylinder 44 can be made of metal or a thermosetting plastic or a fiber-reinforced plastic.

The mating conical surfaces 19 and 21 of the reinforcing cylinder 44 cooperate, as before, with the first conical surface 18 of the ring nut 17 placed on the external thread 16 of the core 11 in the end region 14 and the second conical surface 20 arranged in the end region 13 of the core 11. In this design, the mating conical surfaces 19 and 21 of the reinforcing cylinder 44 are centered between the conical surfaces 18 and 20, and are frictionally clamped after the ring nut 17 has been threaded onto the external thread 16 of the end region 14 of the core 11. This reinforcing cylinder 44 can be necessary if the hard rubber layer 12 has inadequate deformation resistance and stiffness, in order to absorb, by virtue of its deformation resistance and stiffness, the clamping and centering forces without deforming.

Moreover, FIG. 4 also shows that, in this second embodiment of the invention, the key 22 projecting from the outer shell of the core 11 is now arranged in a longitudinal groove 23 that is located substantially or even completely in the reinforcing cylinder 44.

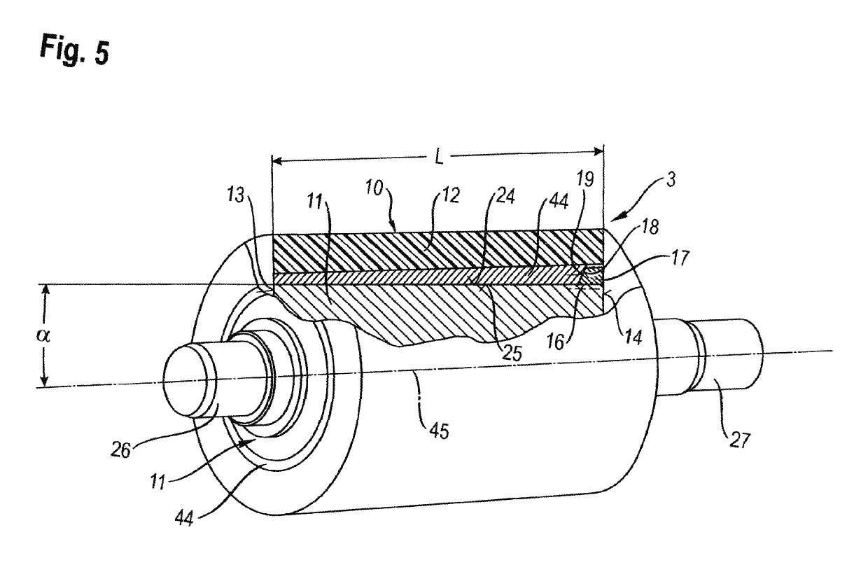

FIG. 5 shows a perspective view, with a region in partial longitudinal cross-section, of a guide roller 3 with replaceable outer hard rubber layer 12 according to a third embodiment of the invention. In this embodiment, a modified reinforcing cylinder 44 is employed, onto which the hard rubber layer 12 is vulcanized. In the axial direction, the reinforcing cylinder 44 has an internal cone 24 in the longitudinal direction with an angle of inclination a between 1°≦α≦5° relative to the axis 45 of the guide roller 3. The sleeve 10 consisting of the hard rubber layer 12 and reinforcing cylinder 44 is arranged on an external cone 25 of the core 11 with an appropriately matched angle of inclination 1°≦α≦5°. For axial securing, as shown in FIG. 5, the ring nut 17 is once again placed on the thread 16 in the end region 14 with the conical surface 18 that cooperates with the mating conical surface 19 in order to axially secure the hard rubber layer 12 that forms the sleeve 10 with conical reinforcing cylinder 44.

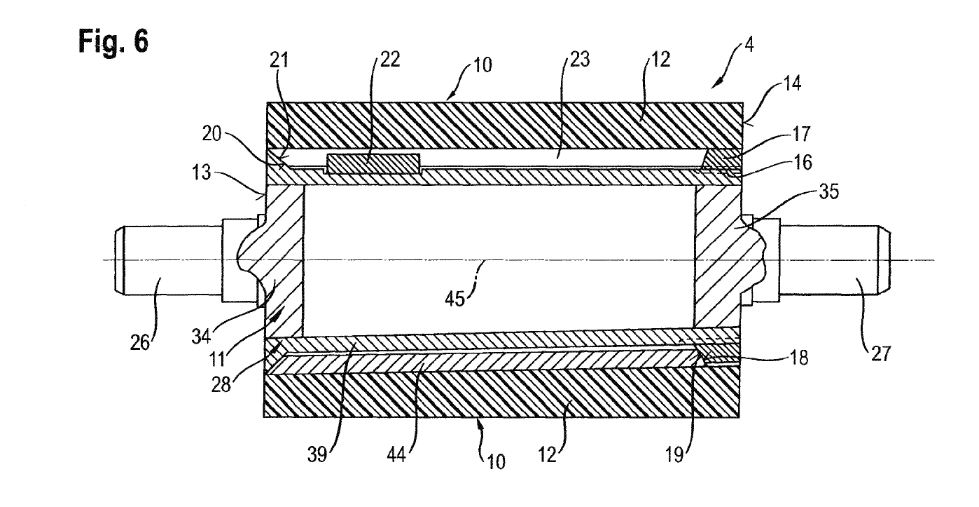

FIG. 6 shows a schematic longitudinal cross-section of a guide roller 4 according to a fourth embodiment of the invention. This embodiment of the invention differs from the first three embodiments in that the core 11 now has a hollow shaft 28 on which the hard rubber layer 12 that forms a sleeve 10 with a reinforcing cylinder 44 is clamped and centered. The hollow shaft 28 is composed of a hollow cylinder 39 and two end plates 34 and 35, wherein the end plate 34 has the journal 26 and the end plate 35 has the journal 27, which project from the end regions 13 and 14 in order to be able to support the guide roller 4 in a housing, for example in a pivotable manner.

In this embodiment, the outer shell of the hollow cylinder 39 now has the conical surface 20, and the ring nut 17 has the conical surface 19, between which is clamped and centered the reinforcing cylinder 44, onto which the hard rubber layer 12 is vulcanized or adhesive bonded or clamped. Moreover, FIG. 6 shows a connection with positive engagement between the hard rubber layer 12 that forms a sleeve 10 with reinforcing cylinder 44 and the hollow cylinder 39, wherein the key 22 that engages the longitudinal groove 23 in the reinforcing cylinder 44 projects from an outer shell of the hollow cylinder 39.

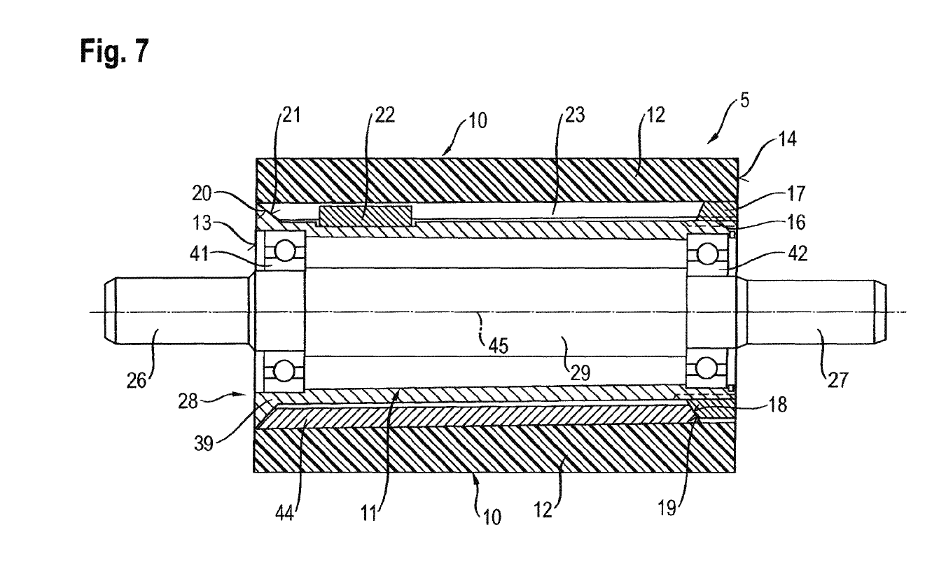

FIG. 7 shows a schematic longitudinal cross-section of a guide roller 5 according to a fifth embodiment of the invention. In this fifth embodiment, the core 11 is once again designed as a hollow shaft 28 that is supported on a fixed axle 29 with the aid of the bearings 41 and 42. The hollow cylinder 39 of the hollow shaft 28 in turn has the conical surface 20 that cooperates with a mating conical surface 21 of the hard rubber layer 12 that forms the sleeve 10 with reinforcing cylinder 44. The outer shell of the hollow cylinder 39 has, in the end region 14, the external thread 16 that engages the ring nut 17. The reinforcing cylinder 44 is clamped and centered by its mating conical surfaces 19 and 21 between the conical surface 18 of the ring nut 17 and the conical surface 20 of the end region 13 of the core 11.

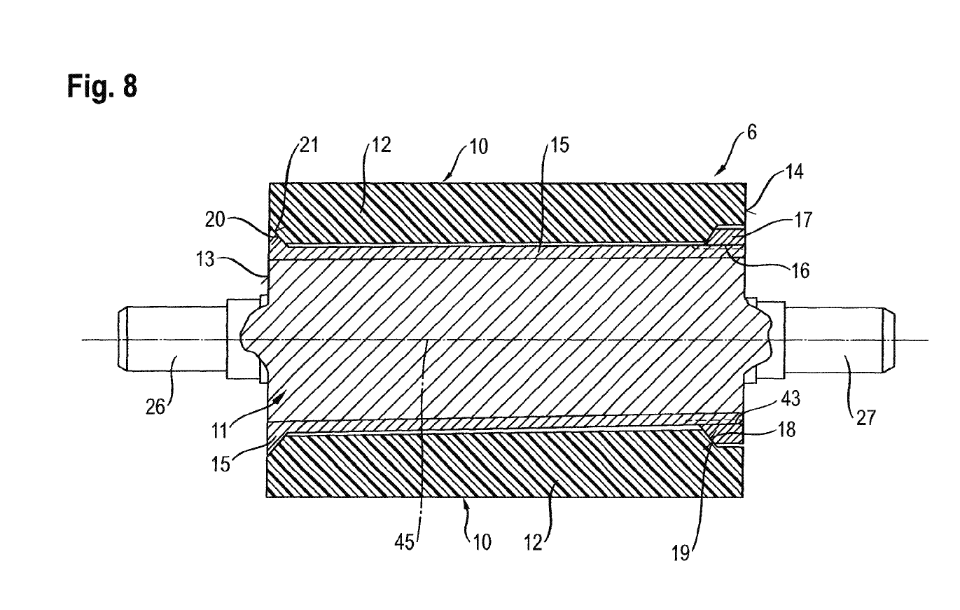

FIG. 8 shows a schematic longitudinal cross-section through a guide roller 6 according to a sixth embodiment of the invention. This embodiment differs from the preceding embodiments 1 through 5 in that a sleeve carrier 15 is now placed between the sleeve 10 and the core 11 in order to secure and center the sleeve 10 with the hard rubber layer 12 on the core 11.

In this sixth embodiment, the hard rubber layer 12 that forms a sleeve 10 has no reinforcing cylinder, but instead, as in FIG. 3, is clamped with its mating conical surfaces 19 and 21 between the first conical surface 18 of the ring nut 17 and the second conical surface 20, which now has the sleeve carrier 15. To this end, the sleeve carrier 15 has the conical surface 20 in the end region 13. The external thread 16 that engages the ring nut 17, which has the conical surface 18, is on an opposite end region 43 on an outer shell of the sleeve carrier 15. In this way, the hard rubber layer 12 that forms the sleeve 10 is centered and clamped on the sleeve carrier 15 by its mating conical surfaces 19 and 21.

This sleeve carrier 15 can be connected to the core 11 with positive engagement by the means that firstly, as before, a key that is not visible in the longitudinal cross-section in FIG. 8 projects from the outer shell of the core 11 and engages an inner longitudinal groove of the sleeve carrier 15 that is not visible in this section plane. On the other hand, it is also possible to use as the core a rod that has an angular, polygonal, or oval profile on at least part of the roller width L.

For this sixth embodiment as well, it is possible to employ a reinforcing cylinder in the event of inadequate strength and stiffness of the hard rubber layer 12. In addition to a connection with positive engagement between the core 11 and the sleeve carrier 15, which for its part carries the sleeve 10 made of a hard rubber layer 12, it is also possible to integrally join this sleeve carrier 15 to the core 11 or even manufacture a core 11 with an integrated sleeve carrier 15 as one piece.

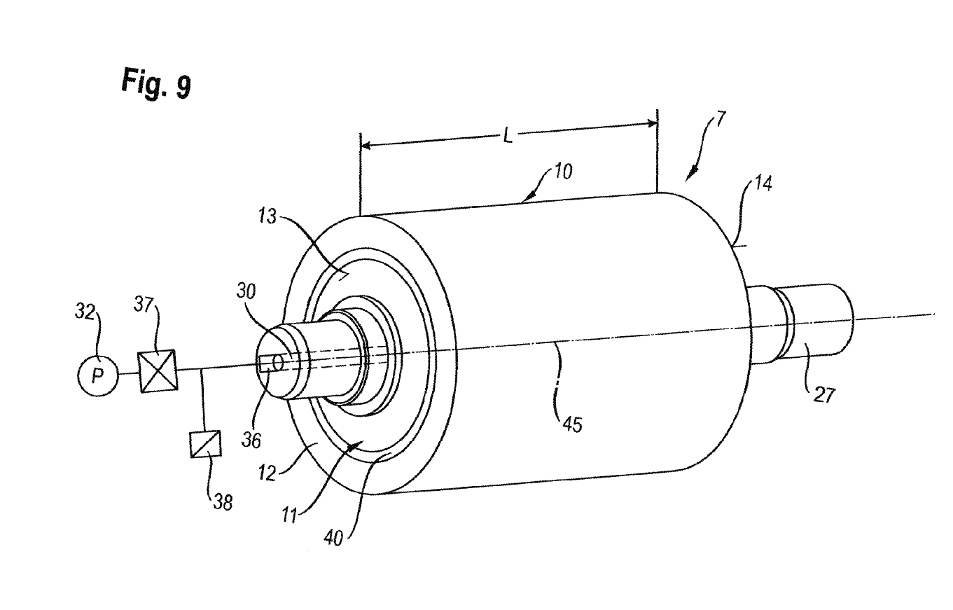

FIG. 9 shows a schematic perspective outside view of a guide roller 7 with replaceable outer hard rubber layer 12 according to a seventh embodiment of the invention. In this embodiment of the invention, a compressible intermediate layer 40 that can be pressed together with compressed air through a central axle bore 30 is arranged between the hard rubber layer 12 and the core 11 so that the sleeve 10 made of a hard rubber layer 12 can be pulled off of the core 11 or can be pushed onto the core with the aid of compressed air that can be delivered through the central axle bore 30. To this end, the central axle bore 30 has a compressed air connection 36 that can be connected to a compressed air source 32 through a pneumatic valve 37, while at the same time a pressure sensor monitors the air pressure when the hard rubber layer 12 that forms a sleeve 10 is pushed on and pulled off.

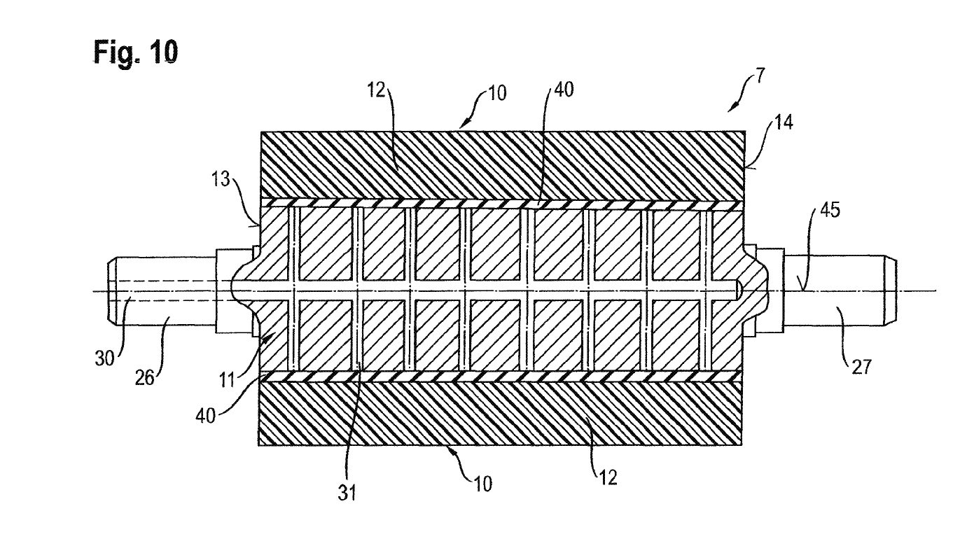

FIG. 10 shows a schematic longitudinal cross-section of the guide roller 7 from FIG. 9, wherein the compressed air, which can be supplied through the central axle bore 30, is directed through additional radial bores 31 in the core 11 toward the compressible intermediate layer 40. In this way, this compressible intermediate layer 40 can be compressed when the compressed air is applied so that a cylindrical gap arises between the core 11 and the sleeve 10. In this way it is possible for the hard rubber layer 12 to be pulled off of the core 11 without difficulty, or else to be pushed back onto the core 11 with the aid of the compressed air after reconditioning of the outer hard rubber layer 12.

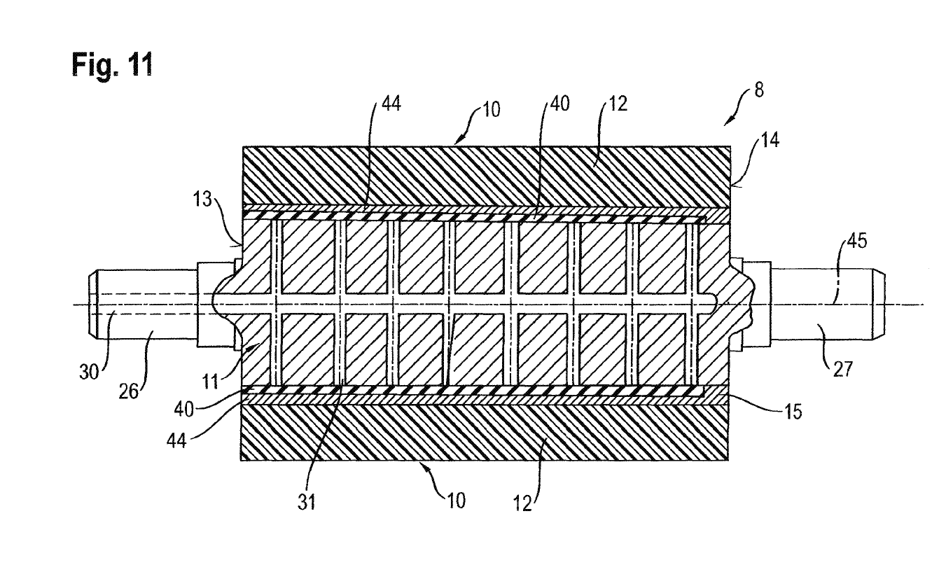

FIG. 11 shows a schematic longitudinal cross-section of a guide roller 8 according to an eighth embodiment of the invention. This guide roller 8 differs from the embodiment of FIG. 10 by the additional provision of a reinforcing cylinder 44 onto which the hard rubber layer 12 is vulcanized, adhesive bonded, or clamped. Between the core 11 and the reinforcing cylinder 44 is now located the compressible intermediate layer 40 that assists in pulling the sleeve 10 off of the core 11 or pushing it on when compressed air is applied in the radial bores 31.

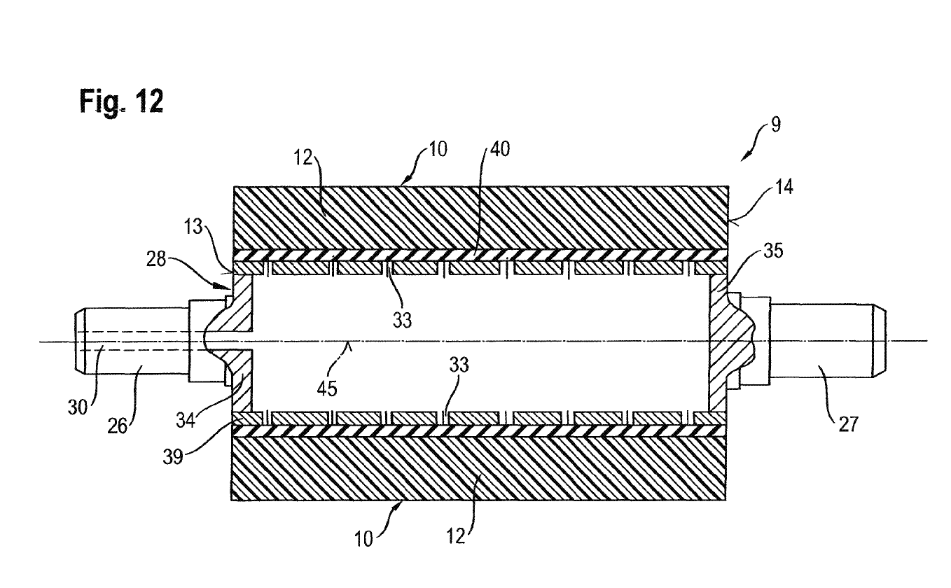

FIG. 12 shows a schematic longitudinal cross-section of a guide roller 9 according to a ninth embodiment of the invention. In this ninth embodiment, the sleeve 10 is placed on a hollow shaft 28 with a hollow cylinder 39 and end plates 34 and 35. Located between the sleeve 10 made of a hard rubber layer 12 and the hollow shaft 28 is once again the compressible intermediate layer 40, which here eases the replacement of the sleeve 10 with the hard rubber layer 12 when compressed air is applied to the hollow shaft 28 through the central axle bore 30. The compressed air compresses the compressible intermediate layer 40 through radial openings 33 to make it possible to pull the sleeve 10 from the core 11 or push it onto the core 11 without difficulty.

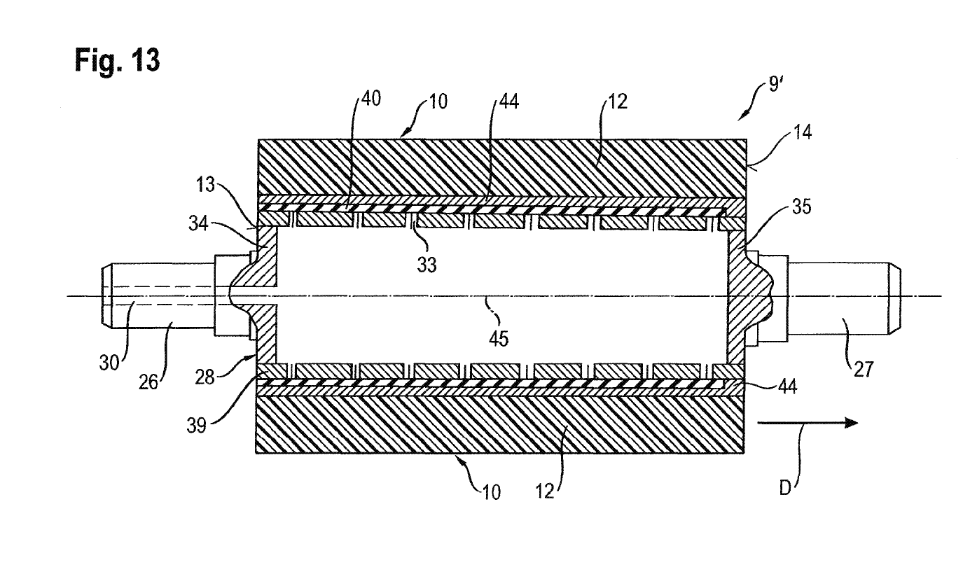

FIG. 13 shows a schematic longitudinal cross-section of a guide roller 9′ according to another embodiment of the invention. This embodiment differs from the preceding embodiment of FIG. 12 only in that a reinforcing cylinder 44 is now provided that supports the stability and shape of the sleeve 10. Because of the special design of this reinforcing cylinder 44, the sleeve 10 is pushed down the hollow shaft 28 in the direction of the arrow D through the air pressure by the hollow cylinder 39 when compressed air is applied to the hollow shaft 28. In this way, the compressed air assists in pulling off the sleeve 10 with reinforcing cylinder 44 that is to be replaced.

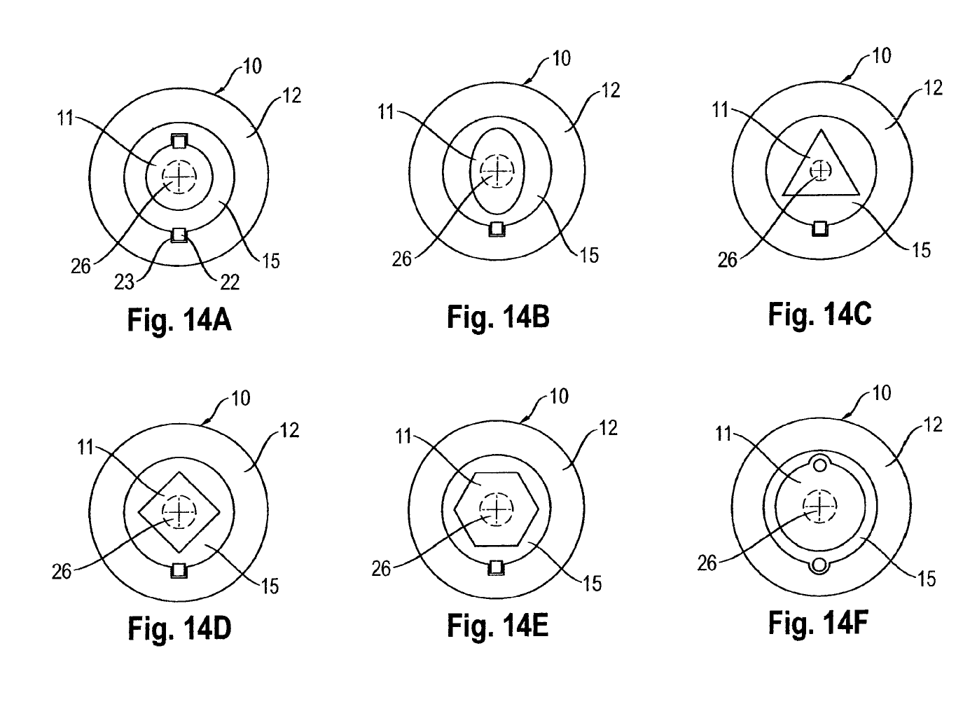

FIG. 14 shows schematic cross-sections of a guide roller with FIGS. 14A through 14F. Between the hard rubber layer 12 and the core 11 of the guide rollers 1 to 3 and 7 and 8 from FIGS. 1 through 5 and 8 through 11, or between the hard rubber layer 12 and the sleeve carrier 15 from FIG. 6, a key and groove connection with positive engagement is possible, as shown in FIGS. 14 A through 14 E for the positive engagement of the hard rubber layer 12 that forms a sleeve 10.

In order to connect the different options of, for example, a sleeve carrier 15 to the core 11 with positive engagement, it is possible to guarantee a positive engagement through a key and groove connection between the sleeve carrier 15 and the core 11, as shown in FIG. 14A.

In FIG. 14B, the positive engagement between the sleeve carrier 15 and the core 11 is achieved through an oval profile of the core 11 with respect to the sleeve carrier 15. To this end, the core 11 need not be oval in design throughout. It is sufficient if only a narrow region, for example an end region, of the core 11 and of the sleeve carrier 15 is oval in design.

In FIG. 14C, the positive engagement is achieved through a profile of the core 11 that is triangular, in FIG. 14D through one that is quadrilateral, and in FIG. 14E through one that is hexagonal, wherein in general any polygonal cross-section of the core 11 permits a positive engagement with the sleeve carrier 15.

In FIG. 14F, the positive engagement both between sleeve 10 and sleeve carrier 15 and between sleeve carrier 15 and core 11 is achieved through keys that are designed as balls or as rollers. These keys can engage suitably adapted longitudinal grooves in order to achieve the positive engagement.

In addition to the structures for positive engagement shown by way of example in FIGS. 14A through 14F, other equivalent structures are, of course, also possible, e.g. multisplining as well.

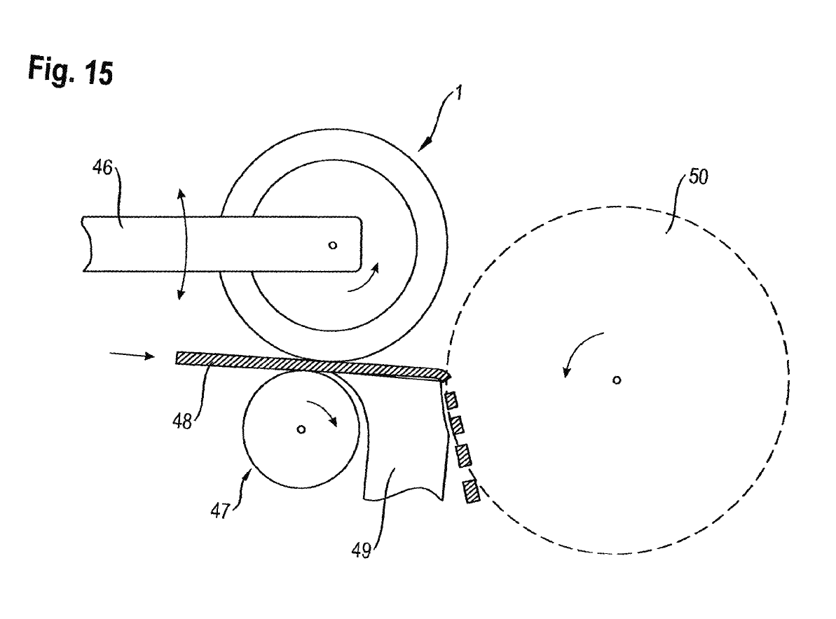

FIG. 15 schematically shows the use of a guide roller according to the invention in a strand pelletizing apparatus. Here, the guide roller 1 designed according to the invention is pivotably supported on a carrier 46 in or on the housing (not explicitly shown) of the strand pelletizing apparatus, as is indicated by the corresponding double arrow in the figure. For easier accessibility, owing to the pivotability the guide roller 1 can also be raised upward in the drawing in its entirety from the drive roller 47, which is rotatably mounted in a fixed position in the housing and is driven by a motor (not shown). Preferably the guide roller 1 is pressed in the direction against the drive roller 47 by its own weight and the weight of the support 46 or by suitable mechanical pressing devices, e.g., by suitably positioned pneumatic pressure cylinders. Together, the guide roller 1 according to the invention and the drive roller 47 thus form a pair of feed rollers of the strand pelletizing apparatus by means of which one or more strand/strands 48 passing therebetween under the influence of the clamping force between the guide roller 1 and drive roller 47 (see arrow in the figure) is/are delivered in a manner known per se to a combination of a stationary blade 49 and a rotating blade 50 so as to be cut there into granules as shown in the figure. The directions of rotation of the guide roller 1, the drive roller 47, and the rotating blade 50 are represented in the figure by arrows.

Even though embodiments that are at least exemplary have been presented in the preceding description, various changes and modifications may be undertaken. The specified embodiments are merely examples and are not intended to restrict in any way the scope of validity, the applicability, or the configuration of the guide roller of a pair of feed rollers of a granulating device. Instead, the preceding description provides the person skilled in the art with a plan for implementing at least one exemplary embodiment of the guide roller, wherein numerous changes can be made in the function and construction of the guide roller from details of the guide roller shown in exemplary embodiments without departing from the scope of protection of the appended claims and their legal equivalents.

### LIST OF REFERENCE CHARACTERS

1 guide roller
2 guide roller
3 guide roller
4 guide roller
5 guide roller
6 guide roller
7 guide roller
8 guide roller
9 guide roller
10 sleeve
11 core
12 hard rubber layer
13 end region
14 end region
15 sleeve carrier
16 external thread
17 ring nut
18 conical surface
19 mating conical surface
20 conical surface
21 mating conical surface
22 key
23 longitudinal groove
24 internal cone
25 external cone
26 journal
27 journal
28 hollow shaft
29 fixed axle
30 central axle bore
31 radial bore
32 compressed air source
33 radial openings
34 end plate
35 end plate
36 compressed air connection
37 pneumatic valve
38 pressure sensor
39 hollow cylinder
40 intermediate layer
41 bearing
42 bearing
43 end region
44 reinforcing cylinder
45 axis
46 support
47 drive roller
48 strand/strands
49 stationary blade
50 rotating blade
α a angle of inclination
A region
B region
L roller width

1. A guide roller of a pair of feed rollers of a granulating device for plastic strands comprising:
the guide roller has a core and at least one outer hard rubber layer,
the at least one outer hard rubber layer forms a sleeve that is configured to be pushed onto the core of the guide roller and pulled off of the core.

2. The guide roller according to claim 1, further comprising:
A first end region of the core has an external thread onto which a ring nut is configured to be threaded a first conical surface of the ring nut engages a first mating conical surface of the outer hard rubber layer that forms the sleeve;
a second end region opposite the first end region of the core has a second conical surface that engages second mating conical surface opposite the first mating conical surface of the outer hard rubber layer that forms the sleeve;
wherein the sleeve is centered with first and second mating conical surfaces by the first and second conical surfaces.

3. The guide roller according to claim 1, further comprising:
a key projecting in an axial direction from the core, the key positively engages with an inner longitudinal groove of the outer hard rubber layer during the pushing on and the pulling off.

4. The guide roller according to claim 1, wherein the sleeve of the hard rubber layer has an internal cone that is frictionally connected to an external cone of the core.

5. The guide roller according to claim 4, further comprising
a key projecting in an axial direction from the external cone of the core positively engages with an inner longitudinal groove of the internal cone of the outer hard rubber layer during the pushing on and the pulling off.

6. The guide roller according to claim 1, wherein the hard rubber layer is vulcanized or adhesive bonded or clamped onto a reinforcing cylinder, and the sleeve with the reinforcing cylinder is arranged on the core.

7. The guide roller according to claim 6, wherein the reinforcing cylinder has mating cones that are arranged such that they are clamped and centered between a front cone of the core and a cone of a ring nut which is configured to be threaded to a first end region of the core.

8. The guide roller according to claim 6, wherein the reinforcing cylinder has an inner longitudinal groove that engages a key projecting from an outer shell of the core.

9. The guide roller according to claim 6, wherein the reinforcing cylinder arranged on the core includes a thermosetting plastic, a fiber-reinforced plastic, or a metal alloy.

10. The guide roller according to claim 6, wherein the outer hard rubber layer is arranged on a sleeve carrier with or without a reinforcing cylinder.

11. The guide roller according to claim 10, further comprising
A first end region of the sleeve carrier has an external thread onto which can be threaded a ring nut;
a first conical surface of the ring nut engages a first mating conical surface of the outer hard rubber layer
a second end region opposite the first end region has a second conical surface that engages second mating conical surface opposite the first mating conical surface, and wherein the sleeve with its first and second mating conical surfaces is centered by the first and second conical surfaces.

12. The guide roller according to claim 10, wherein the sleeve consists of the sleeve carrier with at least an outer hard rubber layer has an inner longitudinal groove that engages in the axial direction a key projecting from the sleeve carrier.

13. The guide roller according to claim 10, wherein the sleeve carrier is an integral part of the core.

14. The guide roller according to claim 1, wherein the core of the guide roller has, arranged at first and second ends, journals that are rotatably supported in a housing of the granulating device.

15. The guide roller according to claim 1, wherein the core of the guide roller has a hollow shaft that is rotatably supported on a fixed axle.

16. The guide roller according to claim 1, wherein the core of the guide roller has radial bores that communicate with a central axle bore, wherein the central axle bore of the core has a compressed air connection.

17. The guide roller according to claim 1, wherein:
the core of the guide roller is a hollow shaft that has radial openings and has compressed-air-tight end plates with journals at its end regions, wherein at least one journal has a central axle bore, and
the central axle bore in the journals of the core have a compressed air connection that is configured to connect to a compressed air source during the pushing on and the pulling off of the outer hard rubber layer.

18. The guide roller according to claim 15, further comprising:
an intermediate layer made of compressible material is arranged between the core and the hard rubber layer
the core having radial bores or radial openings enclosed by the sleeve with at least the hard rubber layer.
